(19) United States
(12) Patent Application Publication
(10) Pub. No.: US 2021/0240775 A1
(43) Pub. Date: Aug. 5, 2021

(54) SYSTEM AND METHOD FOR PROVIDING AUTOMATED AND UNSUPERVISED INLINE QUESTION ANSWERING

(71) Applicant: Intuit Inc., Mountain View, CA (US)

(72) Inventors: Chang LIU, Edmonton (CA); Pankaj GUPTA, Mountain View, CA (US); Homa FOROUGHI, Edmonton (CA)

(73) Assignee: Intuit Inc., Mountain View, CA (US)

(21) Appl. No.: 16/779,699

(22) Filed: Feb. 3, 2020

(51) Int. Cl. G06F 16/9032; G06F 16/9035; G06F 9/451

(52) U.S. Cl. CPC G06F 16/90332; G06F 9/453; G06F 16/9035

(57) ABSTRACT

Systems and methods configured to provide automated and unsupervised inline question-answering in an online community.

### BACKGROUND

It is known that good customer service is essential to the success any corporation's business or service. One essential form of customer service is providing help when users request it. In today's world, help may be provided through a frequently asked questions (FAQ) web page, question and answer (Q&A) forums and or articles written by the business' experts for online services or a help menu for offline services. This sort of “self-help” remedy may be a fast way for the user to get a response, but the results may be less pertinent or personalized than expected.

A more traditional approach that may provide better one-on-one support is when a user places a call to a customer care agent. However, this requires the user to pick up the phone, most likely navigate an interactive voice response system to describe its problem and or wait for an agent to become available. All of which are undesirable.

Some businesses provide a chatbot feature for their online services. A chatbot (a concatenation for “chat robot”) is a piece of software that attempts to conduct a conversation with a user via auditory and or textual methods. Some currently available chatbots are based on machine learning models while others are not.

The chatbots that are not based on a machine learning model may only provide answers to a very small percentage of user questions. The answers may be in the form of inline textual snippets. But these chatbots must be hand-crafted and or are heuristic because they do not have a machine learning backend model. Moreover, these chatbots are not scalable to the diverse set of questions that users may ask and the even more diverse ways in which the questions are asked. In a majority of cases (almost 97%) the chatbots that are not based on machine learning models are not able to return an answer, or the answer obtained is not confident enough to be useful. For example, as shown in FIG. 1, the typical user question-answering experience 10 involves the user entering a question 22 in a chatbot interface 20. In the typical scenario, the chatbot interface 20 may provide the user with a few links 24 (e.g., up to 5 links) to a FAQ search result or other online articles. Based on analysis of clickstream data, users do not often click on those search results. However, when the users decide to click on one of the links 24, they are presented with a wall of text 30 that is content heavy and often too long to read; these users often end up calling customer service 40 for the answer to its question. This experience is also undesirable.

Chatbots that are based on machine learning models are not without their shortcomings. For example, state-of-the-art machine reading systems do not lend well to low-resource labeled question-and-answer pairs. Moreover, obtaining training data for question-answering (QA) is time-consuming and resource-intensive, and existing datasets are only available for limited domains. In addition, this situation may lead to the creation of contact or product attrition, which is undesirable.

Furthermore, when a user asks an application for information or help, it should not matter how she phrases the request or whether she uses specific keywords. That is, asking “Is my income keeping up with my expenses?” should be just as effective as “What's my current cash flow situation?” This is a challenging requirement for any chatbot, but it may be a critical one for delivering an experience that truly delights users. Accordingly, there is a need and desire to provide a question-answering process (e.g., chatbot) capable of providing an answer to a user's question that is both responsive to the question asked, regardless of how asked, and presented in a manner that may focus the user on the substance of the answer.

### BRIEF DESCRIPTION OF THE FIGURES

FIG. 1 shows an example of the conventional question-answering user experience.

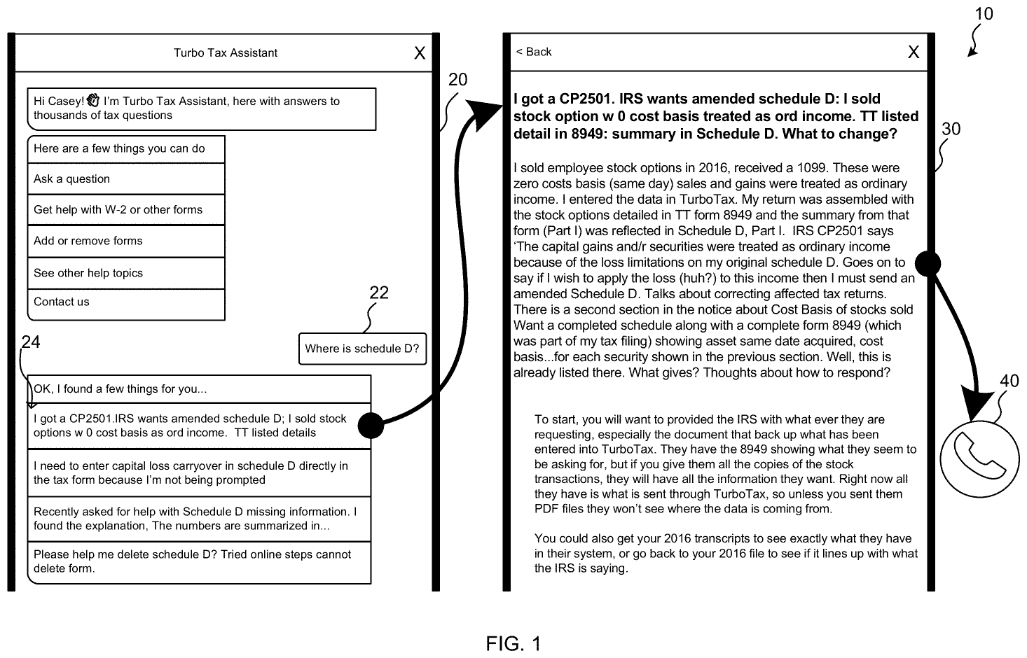

FIG. 2 shows an example of a system configured to provide automated and unsupervised inline question-answering according to an embodiment of the present disclosure.

FIG. 3 shows a server device according to an embodiment of the present disclosure.

FIG. 4 shows an example process for providing automated and unsupervised inline question-answering according to an embodiment of the present disclosure.

FIG. 5 shows an example of the question-answering user interface according to the disclosed principles.

FIG. 6 shows an example process for searching a community repository for a question similar to the user's question that may be performed by the process illustrated in FIG. 4.

FIG. 7 shows an example process for extracting and displaying a summary of the answer to the user's question that may be performed by the process illustrated in FIG. 4.

### DETAILED DESCRIPTION OF SEVERAL EMBODIMENTS

The disclosed systems and methods may overcome the deficiencies of prior art question-answering systems and methods by providing a domain specific unsupervised question-answering process, which is capable of providing inline answers to a diverse set of user questions regardless of how they are asked. In one or more embodiments, the disclosed principles may seek to promote the content of a single article from a repository associated with an online community, select a short inclusive snippet of the article, and display the snippet to the user. In one or more embodiments, the snippet is displayed only after the disclosed system and or method has determined that there is a high level of confidence that the snippet satisfies the user's query. In one or more embodiments, the snippet is provided as a normal conversational response to the user's question via a chatbot or other question-answering user interface. The successful result of the disclosed principles may reduce contact escalation and promote greater product conversion by improving the answers the users need to continue with the service or use of the product.

An example computer-implemented method comprises receiving a user from a device operated by a user; searching a community repository for a plurality of community questions similar to the received user question; selecting an answer from the plurality of community questions based on a similarity between the user question and content of the plurality of community questions; and outputting a snippet comprising one or more sentences from the selected answer to the device operated by the user.

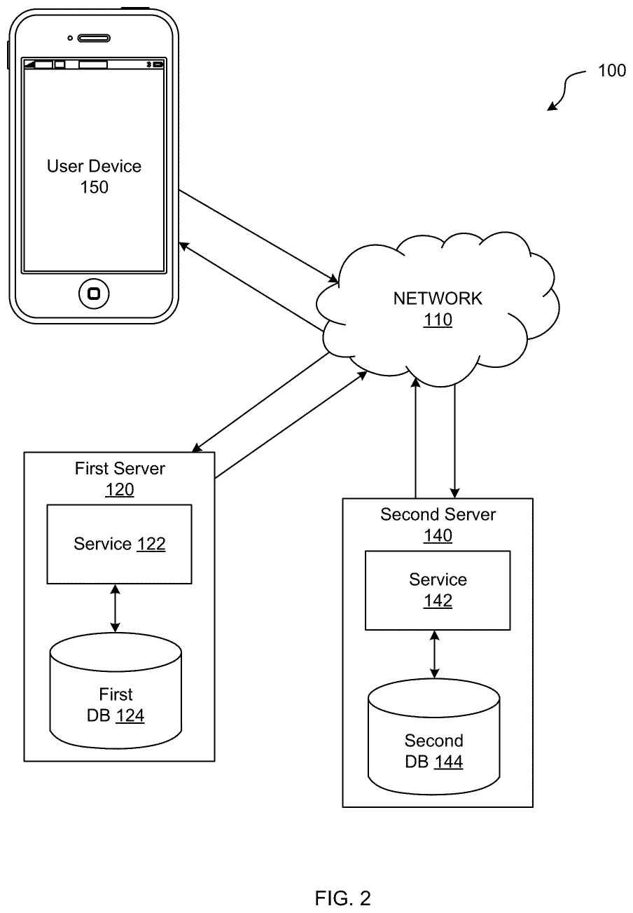

FIG. 2 shows an example of a system 100 configured to provide automated and unsupervised inline question-answering according to an embodiment of the present disclosure. System 100 may include first server 120, second server 140, and/or user device 150. Network 110 may be the Internet and/or other public or private networks or combinations thereof. First server 120, second server 140, and/or user device 150 may be configured to communicate with one another through network 110. For example, communication between the elements may be facilitated by one or more application programming interfaces (APIs). APIs of system 100 may be proprietary and/or may be examples available to those of ordinary skill in the art such as Amazon® Web Services (AWS) APIs or the like.

First server 120 may be configured to provide automated and unsupervised inline question-answering processing according to an embodiment of the present disclosure as described herein. First server 120 may include a first service 122, which may be configured to input and process community data from a data source (e.g., a first database 124, second database 144 or user device 150) and perform the processing disclosed herein. Detailed examples of the data gathered, processing performed, and the results generated are provided below.

First server 120 may also gather data or access models and or other applications from a second server 140 and/or user device 150. For example, second server 140 may include second service 142, which may process and maintain documents and articles related to the system such as the documents and articles of an online community (e.g., TurboTax® Live Community (TTLC)). First service 142 may be any network 110 accessible service that may be used to implement accounting and other services such as e.g., Mint®, TurboTax®, and QuickBooks®, and their respective variants, by Intuit® of Mountain View Calif., other services, or combinations thereof.

User device 150 may be any device configured to present user interfaces and receive inputs thereto. For example, user device 150 may be a smartphone, personal computer, tablet, laptop computer, or other device.

First server 120, second server 140, and user device 150 are each depicted as single devices for ease of illustration, but those of ordinary skill in the art will appreciate that first server 120, second server 140, and/or user device 150 may be embodied in different forms for different implementations. For example, any or each of first server 120 and second server 140 may include a plurality of servers. Alternatively, the operations performed by any or each of first server 120 and second server 140 may be performed on fewer (e.g., one or two) servers. In another example, a plurality of user devices 150 may communicate with first server 120 and/or second server 140. A single user may have multiple user devices 150, and/or there may be multiple users each having their own user device(s) 150.

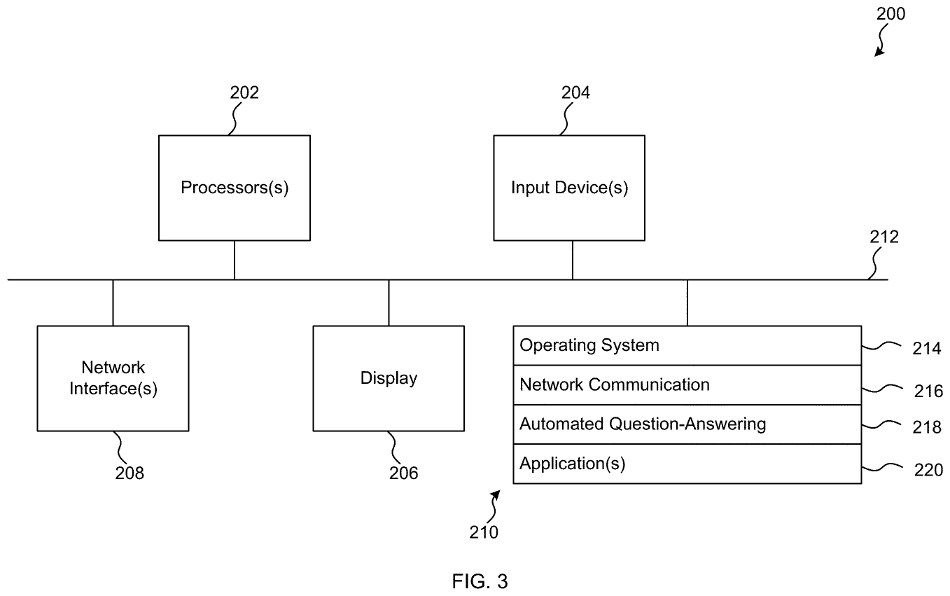

FIG. 3 is a block diagram of an example computing device 200 that may implement various features and processes as described herein. For example, computing device 200 may function as first server 120, second server 140, or a portion or combination thereof in some embodiments. The computing device 200 may be implemented on any electronic device that runs software applications derived from compiled instructions, including without limitation personal computers, servers, smart phones, media players, electronic tablets, game consoles, email devices, etc. In some implementations, the computing device 200 may include one or more processors 202, one or more input devices 204, one or more display devices 206, one or more network interfaces 208, and one or more non-transitory computer-readable media 210. Each of these components may be coupled by a bus 212.

Display device 206 may be any known display technology, including but not limited to display devices using Liquid Crystal Display (LCD) or Light Emitting Diode (LED) technology. Processor(s) 202 may use any known processor technology, including but not limited to graphics processors and multi-core processors. Input device 204 may be any known input device technology, including but not limited to a keyboard (including a virtual keyboard), mouse, track ball, and touch-sensitive pad or display. Bus 212 may be any known internal or external bus technology, including but not limited to ISA, EISA, PCI, PCI Express, NuBus, USB, Serial ATA or FireWire. Computer-readable medium 210 may be any medium that participates in providing instructions to processor(s) 202 for execution, including without limitation, non-volatile storage media (e.g., optical disks, magnetic disks, flash drives, etc.), or volatile media (e.g., SDRAM, ROM, etc.).

Computer-readable medium 210 may include various instructions 214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 204; sending output to display device 206; keeping track of files and directories on non-transitory computer-readable medium 210; controlling peripheral devices (e.g., disk drives, printers, etc.) which can be controlled directly or through an I/O controller; and managing traffic on bus 212. Network communications instructions 216 may establish and maintain network connections (e.g., software for implementing communication protocols, such as TCP/IP, HTTP, Ethernet, telephony, etc.).

Automated question-answering instructions 218 may include instructions that perform a method of providing automated and unsupervised inline question-answering as described herein. Application(s) 220 may be an application that uses or implements the processes described herein and/or other processes. The processes may also be implemented in operating system 214.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a backend component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

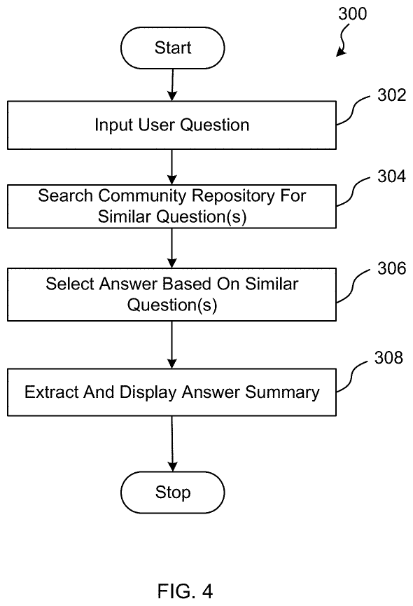

FIG. 4 illustrates an example process 300 for providing automated and unsupervised inline question-answering according to an embodiment of the present disclosure. System 100 may perform some or all of the processing illustrated in FIG. 3. In one embodiment, at step 302, the process 300 may receive or input a user's question. In one embodiment, the user's question may be received or input through a user interface providing a chatbot or other mechanism for inputting a textual or an audible question.

Most current question-answering systems attempt to retrieve an answer from a set of documents, or generate an answer from a data source. The disclosed principles, on the other hand, uses a different approach by using information and resources from an online community associated with the relevant service or product. The online community (connected via the Internet) may contain vast amounts of knowledge including questions that have already been answered, along with those answers. Accordingly, in one or more embodiments, the process 300 may overcome the deficiencies of the prior art by exploring the concept of an unsupervised question-answering process, providing a setting in which no aligned question, context and answer data is available.

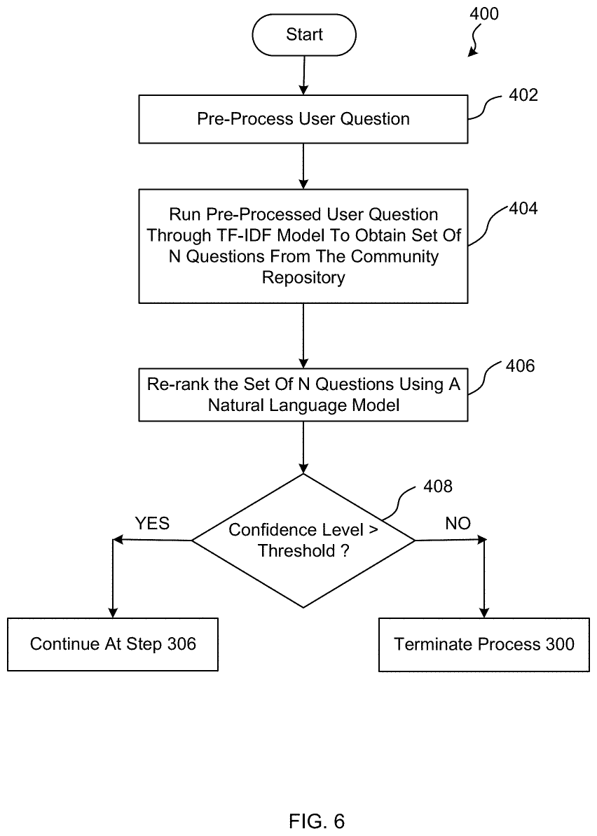

Specifically, rather than developing answers for potential questions in advance, the disclosed process 300 may use already answered questions from an online community associated with the relevant service or product. For example, if the process 300 were being implemented for a TurboTax® service, the process 300 would use information from a TurboTax® Live Community (TTLC) to locate answers to a user's question input at step 302. Thus, in one embodiment, at step 304, the process 300 may search to find the most similar questions to the one input at step 302 from among questions maintained in a community repository of questions and answers. If there is more than one relevant question, the process 300 may choose the closest one (discussed in more detail below). In one embodiment, discussed below with reference to FIG. 6, a confidence level for the search may be compared to a predetermined threshold. If the confidence level for the search is greater than the predetermined threshold, the process 300 may proceed. However, if the confidence level for the search is not greater than the predetermined threshold, the process 300 may terminate and may cause one of the conventional question-answering processes to be performed.

At step 306, a best answer to the question input at step 302 may be selected. It may be possible for some questions to have more than one related answer; in these situations, the process 300 may prioritize the best answer by prioritizing certain content (e.g., FAQ articles and content written by promoted/trusted users of the system) over other content (e.g., content written by other users). It is very common in forum-like pages for different users to answer the same question in different ways. It is one object of the disclosed principles to select the best answer from among all of the relevant answers. As can be appreciated, delivering high-quality and relevant answers to the user may be beneficial for the business or service and can develop brand loyalty.

Accordingly, in one embodiment, a rule-based mechanism is used to prioritize certain trusted content over other content in the community. For example, content provided internally by the business, it's employees or affiliates (i.e., internally generated content or “IGC”) will be ranked higher than user generated content (UGC). When no relevant internally generated content is found, the process 300 may prioritize the content written by trusted users or users with the highest and or normalized feedback (e.g., “up” or “like” votes) in the community. In one embodiment, the process 300 may use the combination of natural language understanding (NLU) and a rule-based method to prioritize the answers and select the best answer. In one embodiment, the process 300 may prioritize the answer having the highest similarity to the user's question based on e.g., their semantic similarity computed based a neural word/sentence embedding process.

Once the best answer is selected the process at step 308 may extract and display a snippet (i.e., one or more sentences, but no more than ten sentences) of the selected answer. For example, if the retrieved answer is an article, the process 300 may automatically highlight an important part of the article to help the user read the article, particularly if the answer is a long article. As discussed below in more detail below, the extraction presented to the user may be made according to defined metrics and without making any changes to the text of the answer (i.e., is a snippet of existing text). In one embodiment, an overall confidence level that the user's question has been answered may be compared to a predetermined threshold. In that embodiment, if the overall confidence level is greater than the predetermined threshold, the process 300 may proceed to display the snippet of the answer. In that embodiment, however, if the overall confidence level is not greater than the predetermined threshold, the process 300 may terminate without displaying the snippet of the answer, and may cause one of the conventional question-answering processes to be performed.

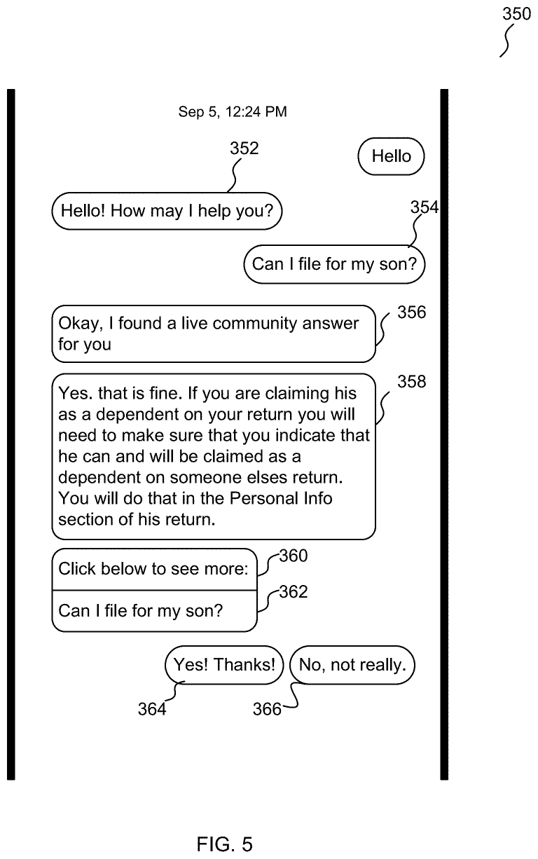

FIG. 5 shows an example of the question-answering user interface 350 according to the disclosed principles. In the illustrated example, the user interface 350 presents the user with a greeting in a conversation bubble 352 such as e.g., “Hello! How may I help you?” The user may enter a question in an input field (not shown) provided in the interface 350 and once entered, the user's question is presented in a conversation bubble 354. In the illustrated example, the user's question is “Can I file for my son?” At this point, process 300 may execute and may return an answer to the user. In one embodiment, a conversation bubble 356 may be presented on the interface 350 to let the user know that an answer was found via e.g., a message that states “Okay! I found a live community answer for you.” In the illustrated embodiment, another conversation bubble 358 is presented on the interface 350 and contains the snippet of text answering the user's question in accordance with the disclosed principles.

In one or more embodiments, the interface 350 may include another conversation bubble 360 alerting the user that more options are available such as e.g., with the message “Click below to see more:”. In the illustrated example, another conversation bubble 362 proximate to conversation bubble 360 contains a selectable link in the form of text, which may be the user's original question “Can I file for my son?” or other text. The illustrated example also includes a first selectable field 364 in which the user confirms that the answer provided in conversation bubble 358 answered the user's question. In the illustrated example, first selectable field 364 contains the text “Yes! Thanks!” and the selection of first selectable field 364 indicates to the system that the user's question has been satisfactorily answered.

The illustrated example also includes a second selectable field 366 in which the user alerts the system that the answer provided in conversation bubble 358 did not answer the user's question. In the illustrated example, second selectable field 366 contains the text “No, not really” and the selection of second selectable field 366 indicates to the system that the user's question was not satisfactorily answered. In one embodiment, if it is detected that the second selectable field 366 was selected, the process may provide links to the most related articles within the community repository that may have answered the same or similar question.

In one or more embodiments, the search of the community repository for a question similar to the question input by the user (e.g., step 304 of FIG. 4) may be performed in accordance with the example processing 400 illustrated in FIG. 6. For example, at step 402, the user's question is initially cleaned and scrubbed by a customized pre-processing process. In one or more embodiments, the pre-processing may include multiple levels of processing (i.e., a “multi-level process”). For example, in a first level, the pre-processing may include stemming (i.e., the process of reducing inflected or derived words to their word stem, base or root form) and or the removal of non-English text or other symbols from the user's question. In another slightly more complex level, the pre-processing may include the removal of profanity and or other objectionable bad content (e.g., rape, drugs, abuse, etc.) from the user's question that may be found in a database of profane language and or other objectionable bad content as determined by a system administrator. This level of pre-processing may also include the removal of capital letters, punctuation marks and or other esthetical features of the user's question. Moreover, another pre-processing function may remove articles such as “a,” “an,” “the,” etc. from the user's question. It should be appreciated that some or all of the above-described pre-processing may be omitted if desired.

The remainder of process 400 takes advantage of a large amount of pre-answered questions available in the community repository by mapping the user's question to the questions and answers in the live community repository, which may include articles and or other text developed by or for the relevant community. In general, the criteria for two questions to be similar is that they seek the same answer.

At step 404, the process 400 may run the pre-processed user question through a Term Frequency-Inverse Document Frequency (TF-IDF) model. To perform step 404, the process 400 may have previously trained the TF-IDF model on all existing articles and documents within the community repository. In general, the TF-IDF model outputs the relative importance of each word in each document in comparison to the rest of the corpus. The number of times a term occurs in a document is known as the term frequency. Inverse document frequency is used to diminish the weight of terms that occur very frequently in the document set, but increases the weight of terms that occur rarely. For example, a TF-IDF score increases proportionally to the number of times a word appears in a document and is offset by the number of documents in the corpus that contain the word, which may adjust for the fact that some words appear more frequently in general.

In one embodiment, the TF-IDF model may compute a score for each word in each document, thus approximating its importance. Then, each individual word score is used to compute a composite score for each question in the community repository by summing the individual scores of each word in each sentence. The output of the TF-IDF model, and step 404, may be a set of ranked questions relevant to the pre-processed user question (e.g., a ranked set of potential questions). In one embodiment, the set may comprise a predetermined number N of questions as being relevant to the user's question. In one embodiment, the predetermined number N is 100, but it should be appreciated that the disclosed principles are not limited to a specific size.

It is known that TF-IDF based models are not as effective when there is no vocabulary overlap. Often times, there is semantic similarity between sentences. Accordingly, at step 406, the process 400 may perform additional processing to re-rank the top N retrieved questions using one or more natural language models that are capable of capturing semantic similarity. These models generate computer-friendly numeric vector representations for words found in the documents. The goal is to represent a variable length sentence as a fixed length vector. For example, “hello world” may be represented as [0.1, 0.3, 0.9]. In accordance with the disclosed principles, each element of the vector should “encode” semantics from the original sentence.

In one embodiment, step 406 is performed using a Bidirectional Encoder Representations from Transformers (BERT) model, which is a deep learning model related to natural language processing. The BERT model helps the processor understand what words mean in a sentence, but with all of the nuances of context. BERT makes use of Transformer, an attention mechanism that learns contextual relations between words (or sub-words) in a set of text. In one form, Transformer includes two separate mechanisms—an encoder that reads the text input and a decoder that produces a prediction for the task. As opposed to directional models, which read the text input sequentially (left-to-right or right-to-left), the Transformer encoder reads the entire sequence of words at once. Therefore, it is considered bidirectional. This characteristic allows the model to learn the context of a word based on all of its surroundings (i.e., left and right of the word).

Using the natural language model, the process 400 may compute the numerical sentence embedding for each of the N retrieved questions, and re-rank them based on their cosine similarity (a metric used to measure how similar the questions are irrespective of their size. Mathematically, it measures the cosine of the angle between two vectors projected in a multi-dimensional space). The retrieved question from the set of N questions with the highest similarity to the pre-processed user question is considered to be the “best matched question.”

At step 408, it is determined if a confidence level of the returned results are greater than a predetermined search confidence threshold. In one embodiment, process 300 will only continue (at step 306 of FIG. 4) if the confidence level of the returned results is greater than the predetermined search confidence threshold. Otherwise, the process 300 is terminated. In one embodiment, the confidence level is defined based on a similarity of tokens found in the user's question to the tokens found in the retrieved questions from the live community.

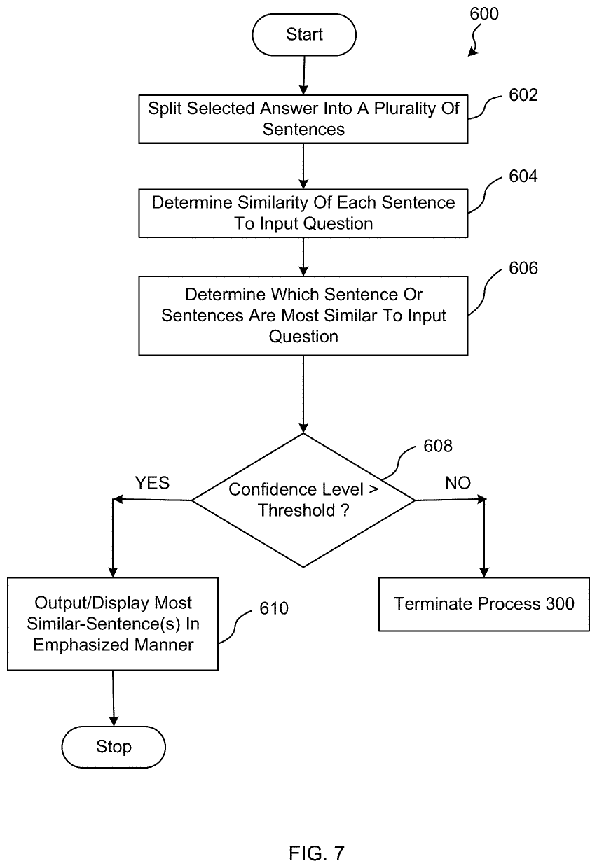

In one or more embodiments, the extraction and display of the snippet of the answer to the user's question (e.g., step 308 of FIG. 3) may be performed in accordance with the example processing 600 illustrated in FIG. 7. For example, at step 602, the process may first split the best selected answer into several sentences and at step 604 may determine how similar each sentence is to the user's question. In one embodiment, to compute the similarity, each sentence is represented by a neural embedding as described above for the searching step (e.g., step 304 of FIG. 4), and then at step 606 the most important sentences (i.e., the ones most similar to the user's question) are selected.

At step 608, it is determined if a confidence level of the extracted snippet is greater than a predetermined confidence threshold. In one embodiment, processes 300/600 will only continue at step 610 if the confidence level of the extracted snippet is greater than the predetermined confidence threshold. Otherwise, the processes 300/600 are terminated. In one embodiment, the confidence level is defined by contextual similarity of the user's question and the best found question. At step 610, the most similar sentence(s) (i.e., the selected snippet) is output and or displayed to the user via e.g., the question-answering user interface (e.g., question-answering user interface 350).

The disclosed principles may use a variety of different embedding techniques during the process 600. The inventors have experimented with individual and concatenated word representations to find a single representation for each sentence. Based on these principles, it was determined that the similarity function should be oriented to the semantics of the sentence and that cosine similarity based on a neural word/sentence embedding approach may work well for a community based repository.

Accordingly, the disclosed principles may use Word2vec, which is a particularly computationally-efficient predictive model for learning word embeddings from raw text. Word2vec is a two-layer neural network that is trained to reconstruct linguistic contexts of words. It takes as its input a large corpus of words and produces a vector space, typically of several hundred dimensions, with each unique word in the corpus being assigned a corresponding vector in the space. There are two types of Word2vec that may be used with the disclosed principles: the continuous bag-of-words model (CBOW) and the skip-gram model. Algorithmically, these models are similar, except that CBOW predicts target words (e.g., “mat”) from source context words (“the cat sits on the”), while the skip-gram model does the inverse and predicts source context-words from the target words.

It is known that both CBOW and the skip-gram models are predictive models, in that they only take local contexts into account. Word2Vec does not take advantage of the global context. Accordingly, the disclosed principles may use GloVe embeddings, which may leverage the same intuition behind the co-occurring matrix used by distributional embeddings. GloVe uses neural methods to decompose the co-occurrence matrix into more expressive and dense word vectors. Specifically, GloVe is an unsupervised learning algorithm for obtaining vector representations for words. Training is performed on aggregated global word-word co-occurrence statistics from a corpus, and the resulting representations showcase interesting linear substructures of the word vector space.

The disclosed principles may use a Universal Sentence Encoder (USE) in one or more embodiments. USE encodes text into high dimensional vectors. The pre-trained USE comes with two variations i.e., one trained with a Transformer encoder (discussed above) and another trained with Deep Averaging Network (DAN). Either training may be used by the disclosed principles. The USE models may be pre-trained on a large corpus and can be used in a variety of tasks (sentimental analysis, classification and so on). Both models take a word, sentence or a paragraph as input and output a 512-dimensional vector, which can then be analyzed in accordance with the disclosed principles.

The disclosed principles may also use the BERT model (discussed above), which is a language representation model that is designed to pre-train deep bidirectional representations from unlabeled text by jointly conditioning on both left and right context in all layers.

As noted above, there are other question-answering techniques available in the art, but none of them provide the advantages of the disclosed principles, which provide a unique combination of question-to-question matching, best answer selection and answer highlighting (e.g., via a snippet) in an unsupervised process that uses a community repository rather than the traditional process of developing answers for potential questions in advance. In comparison to other question-answering techniques, the disclosed principles utilize less processing and memory resources because answers for potential questions are not pre-developed, stored or processed in advance. This also makes the disclosed principles more efficient and less time intensive as already available community resources form the basis for the question-answering processing. These are major improvements in the technological art as it improves the functioning of the computer and is an improvement to the technology and technical fields of question-answering systems.

For example, the creation of the Stanford Question Answering Dataset (SQuAD) utilizes a large corpus of Wikipedia articles annotated by crowdsourced workers, which lead to research efforts to build advanced reading comprehension systems. In many domains, however, gathering a large labeled training dataset is not feasible due to limits on time and resources. The disclosed principles overcome these issues with the unsupervised nature of the question-answering processes disclosed herein. Existing research in the question-answering space explores a variety of models for building such systems, from bidirectional attention flow to ELMo (Embeddings from Language Models) and BERT. These efforts primarily focus on building models that perform effectively given the entire SQuAD training corpus. State-of-the-art machine reading systems, however, do not lend well to low-resource question-answering settings where the number of labeled question-answer pairs are limited. On the other hand, large domain specific annotated corpora are limited and expensive to construct, especially when it comes to financial and tax data, which are updated frequently, and need huge domain expertise to be annotated.

There have been attempts to use unsupervised models for question-answering, but most of them are limited to and reliant on word or sentence embeddings. In these models, each word/sentence is represented by a numeric representation (i.e., an embedding) and the retrieval is performed based on the similarity of these embeddings; that is, the sentences with the most similarity (smallest distances are chosen) as the extractive answer. But these models do not utilize the unique combination of question-to-question matching, best answer selection and answer highlighting in an unsupervised process that uses a community repository as disclosed herein.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A computer implemented method comprising:
receiving a user question from a device operated by a user;
searching a community repository for a plurality of community questions similar to the received user question;
selecting an answer from answers associated with the plurality of community questions based on a similarity between the user question and content of the plurality of community questions; and
outputting a snippet comprising one or more sentences from the selected answer to the device operated by the user.

2. The method of claim 1, further comprising:
outputting a selectable link to the device operated by the user that, when selected, provides access to additional answers associated with the plurality of community questions;
outputting a first selectable field that, when selected, provides an indication that the selected answer provides an answer to the user's question; and
outputting a second selectable field that, when selected, provides an indication that the selected answer did not provide an answer to the user's question.

3. The method of claim 1, wherein searching the community repository for the plurality of community questions similar to the received user question further comprises pre-processing the received user question using a multi-level process to generate a pre-processed user question.

4. The method of claim 3, wherein pre-processing the user question comprises:
a first level comprising stemming words within the user question; and
a second level comprising removing, from the user question, profanity and other language deemed objectionable by a system administrator.

5. The method of claim 3, wherein searching the community repository for the plurality of community questions similar to the received user question further comprises:
inputting the pre-processed user question through a Term Frequency-Inverse Document Frequency (TF-IDF) model to obtain a ranked set of potential questions that are similar to the pre-processed user question; and
re-ranking the ranked set of potential questions using a natural language model.

6. The method of claim 3, wherein searching the community repository for the plurality of community questions similar to the received user question further comprises determining that a confidence level associated with results of the search is greater than a predetermined search confidence threshold.

7. The method of claim 1, wherein selecting the answer from answers associated with the plurality of community questions based comprises using a rule-based method to prioritize answers from internally generated content over answers from user generated content.

8. The method of claim 1, wherein outputting the snippet of the selected answer to the device operated by the user further comprises:
splitting the selected answer into a plurality of sentences; and
determining which sentences from the split selected answer is most similar to the user question.

9. The method of claim 8, wherein determining which sentences from the split selected answer is most similar to the user question comprises:
representing the sentences from the split selected answer using neural embedding; and
comparing the sentences represented with the neural embedding to the user question.

10. The method of claim 8, wherein outputting the snippet of the selected answer to the device operated by the user further comprises further comprises determining that a confidence level associated with the snippet is greater than a predetermined confidence threshold.

11. A system for providing answers to a user device operating a question-answering user interface, said system comprising:
a first computing device connected to a community repository through a network connection, the first computing device configured to:
receive a user question from the user device;
search the community repository for a plurality of community questions similar to the received user question;
select an answer from answers associated with the plurality of community questions based on a similarity between the user question and content of the plurality of community questions; and
output a snippet comprising one or more sentences from the selected answer to the user device operating the question-answering user interface.

12. The system of claim 11, wherein the first computing device is further configured to:
output a selectable link to the user device operating the question-answering user interface that, when selected, provides access to additional answers associated with the plurality of community questions;
output a first selectable field that, when selected, provides an indication that the selected answer provides an answer to the user's question; and
output a second selectable field that, when selected, provides an indication that the selected answer did not provide an answer to the user's question.

13. The system of claim 11, wherein searching the community repository for the plurality of community questions similar to the received user question further comprises pre-processing the received user question using a multi-level process to generate a pre-processed user question.

14. The system of claim 13, wherein pre-processing the user question comprises:
a first level comprising stemming words within the user question; and
a second level comprising removing, from the user question, profanity and other language deemed objectionable by a system administrator.

15. The system of claim 13, wherein searching the community repository for the plurality of community questions similar to the received user question further comprises:
inputting the pre-processed user question through a Term Frequency-Inverse Document Frequency (TF-IDF) model to obtain a ranked set of potential questions that are similar to the pre-processed user question; and
re-ranking the ranked set of potential questions using a natural language model.

16. The system of claim 13, wherein searching the community repository for the plurality of community questions similar to the received user question further comprises determining that a confidence level associated with results of the search is greater than a predetermined search confidence threshold.

17. The system of claim 11, wherein selecting the answer from answers associated with the plurality of community questions based comprises using a rule-based method to prioritize answers from internally generated content over answers from user generated content.

18. The system of claim 11, wherein outputting the snippet of the selected answer further comprises:
splitting the selected answer into a plurality of sentences; and
determining which sentences from the split selected answer is most similar to the user question.

19. The system of claim 18, wherein determining which sentences from the split selected answer is most similar to the user question comprises
representing the sentences from the split selected answer using neural embedding; and
comparing the sentences represented with the neural embedding to the user question.

20. The system of claim 18, wherein outputting the snippet of the selected answer further comprises determining that a confidence level associated with the snippet is greater than a predetermined confidence threshold.
